(19) United States
(12) Patent Application Publication
(10) Pub. No.: US 2014/0161264 A1
(43) Pub. Date: Jun. 12, 2014

(54) System and Method for Sound Level Monitoring at the Location of a Monitored Person

(71) Applicants: Sten Kirkbak, Trondheim (NO); PåL Selnæs, Morrisville, NC (US); Michael Fulbright, Cary, NC (US); Barry Wayne Huggins, Cary, NC (US)

(72) Inventors: Sten Kirkbak, Trondheim (NO); PåL Selnæs, Morrisville, NC (US); Michael Fulbright, Cary, NC (US); Barry Wayne Huggins, Cary, NC (US)

(73) Assignee: FILIP TECHNOLOGIES UK LTD., London (GB)

(21) Appl. No.: 14/103,225

(22) Filed: Dec. 11, 2013

Related U.S. Application Data
(60) Provisional application No. 61/736,413, filed on Dec. 12, 2012.
(60) Provisional application No. 61/748,812, filed on Jan. 4, 2013.

(51) Int. Cl. G08B 21/18; H04R 29/00

(52) U.S. Cl. CPC G08B 21/182; H04R 29/00
USPC 381/56

(57) ABSTRACT

A system of remotely monitoring the sound level at the location of a monitored person. The system includes a first device positioned with a monitored person, a monitoring server that is a hub for communication within the system, and a second device for a monitoring person that is remote from the first device and the monitored person. The first device is configured to detect the occurrence of sound exceeding a sound threshold. The first device then places a call to at least one of the monitoring server and the second device indicating that the sound threshold has been exceeded in the area of the monitored person.

### RELATED APPLICATIONS

The present application claims priority to provisional application No. 61/736,413 filed Dec. 12, 2012 and to provisional application No. 61/748,812 filed Jan. 4, 2013, each of which is herein incorporated by reference in their entireties.

### FIELD OF THE INVENTION

The application is directed to a monitoring system for monitoring the sound level at a remote device, and, more particularly, to a system that notifies a party in the event the sound level at a remote device exceeds a predetermined threshold.

### BACKGROUND

There are many instances in which a user desires to monitor another person at a remote location. One such instance is a parent that wants to monitor their child when the child is away from the parent. Examples include monitoring a sleeping child who is in another room, or when the child is at school or day care. Another instance is monitoring an elderly person that lives alone. In each of these contexts, the monitoring person is at a remote location away from the monitored person.

Various types of monitoring systems have been developed to enable a person at a remote location to monitor another. The systems include a first device at the monitored person and a second device at the monitoring person. The systems provide for the monitoring person to track the monitored person at various times during the day. However, these systems have had various drawbacks.

One issue is the inability of the monitored person to remotely change the settings of the first device that is worn by the monitored person. These systems often require that the monitoring person make such adjustments through the first device itself. Therefore, the monitoring person is not able to make adjustments during the course of the day when the monitored person with the first device is at a remote location.

Another drawback is the complexity of many of the systems. These systems are cumbersome for the monitoring person to obtain information about the monitored person. This may be due to inefficient interfaces that are difficult for users to traverse to obtain such information. Further, the information may be presented in a confusing manner, or an over-abundance of information may be presented to the user.

### SUMMARY

The present application is directed to a system for remotely monitoring a remote person. The system includes a monitoring device and a monitoring server. In one embodiment, the monitoring device is referred to as a child device because it is carried by a child that is being monitored. Remote monitoring of a child is one application of the system, although numerous other applications may also be available. Further, a monitoring person, such as a parent, may access the monitoring server to monitor the remote person. The system provides for the monitoring person to identify the remote person and to activate a sound level monitoring mode at their device. In the event the device experiences a sound level above the threshold, the monitoring person may be notified.

One embodiment is directed to a child device for use in a sound level monitoring system. The child device includes a microphone configured to detect sound at the child device, and a communication circuit configured to communicate through a wireless communication network. The device also includes a control circuit configured to set a sound level threshold based on an input received through the wireless communication network, determine a sound level at the device, determine that the sound level at the device exceeds the sound level threshold, and place a voice call through the wireless communication network that includes the sound occurring at the child device.

The control circuit may be configured to display an indicator on a display screen when a sound level monitoring mode is active within the device and the sound level is being detected.

The device may further include an outer housing with at least one input button, the control circuit configured to place a voice call through the wireless communication network in response to receiving a signal through the at least one input button.

The device may further include a global positioning system component operatively connected to the control circuit and configured to determine a geographic position of the device, wherein the voice call placed through the wireless communication network that includes the sound occurring at the child device further including the geographic position of the device.

Another embodiment is directed to a method implemented by a wireless communication device of providing an indication of an excessive sound level at the device. The method includes activating a sound monitoring mode of the device in response to a request received through a wireless communication network, setting a sound level threshold of the device in response to input received through the wireless communication network, detecting sound at the device, determining a sound level at the device, determining that the sound level at the device exceeds the sound level threshold, and placing a voice call through the wireless communication network that includes the sound that is occurring at the child device.

The request received through the wireless communication network may be a SMS communication.

The method may further include terminating the voice call after a predetermined time period when the sound level at the device continues to exceed the sound level threshold.

The method may further include placing another voice call through the wireless communication network that also includes the sound that is currently occurring at the child device.

The method may further include displaying an indication that the sound monitoring mode is active.

Placing the voice call through the wireless communication network that includes the sound that is occurring at the child device may include placing the voice call to a remote device that established the sound level threshold.

Another embodiment is directed to a method implemented by a monitoring server of remotely monitoring a sound level at a monitored wireless communication device. The method includes receiving an access request at a monitoring server from a monitoring device that includes an identifier of the monitoring device with the monitoring device being remotely located from the child device and the monitoring server, authenticating the monitoring device at the monitoring server based on the identifier of the parent device, after authenticating the monitoring device, sending an activation request to the monitored device to activate a sound level monitoring mode at the monitored device, and sending a sound level threshold to the monitored device based on input received from the monitoring device.

The method may further include receiving at the monitoring server an indication from the monitored device that the sound level threshold has been exceeded at the monitored device.

The method may further include notifying the monitoring party that the sound level threshold has been exceeded by sending the sound occurring at the monitored device at the time.

Receiving the indication from the monitored device that the sound level threshold has been exceeded at the monitored device comprises receiving a voice call from the monitored device that includes the sound occurring at the monitored device at the time of the voice call.

Notifying the monitoring device that the sound level threshold has been exceeded at the monitored device may include routing the voice call from the monitored device that includes the sound occurring at the monitored device at the time of the voice call.

The method may further include receiving an indication from the monitored device that the sound level threshold at the device is no longer being exceeded and terminating the communication with the monitoring device.

Authenticating the monitoring device at the monitoring server based on the identifier of the parent device may include matching identification information of the monitoring device with pre-stored information associated with the monitored device.

The various aspects of the various embodiments may be used alone or in any combination, as is desired.

### BRIEF DESCRIPTION OF THE DRAWINGS

FIG. 1 is a schematic diagram of a sound level monitoring system.

FIG. 2 is a perspective view of a child device.

FIG. 3 is a schematic view of a child device.

FIG. 4 is a schematic view of a monitoring server.

FIG. 5 schematically illustrates an example implementation of a monitoring server database.

FIG. 6 is a schematic view of a parent device.

FIG. 7 is a flow chart illustrating a method implemented by a monitoring server to activate a monitoring mode of a child device.

FIG. 8 is an initial display screen displayed on a parent device.

FIG. 9 is a second display screen displayed on a parent device.

FIG. 10 is a flow chart illustrating a method implemented by a child device to perform sound level monitoring.

FIG. 11 is a flow diagram of a call process between the components of the system.

FIG. 12 is a flow diagram of a call process between the components of the system.

### DETAILED DESCRIPTION

The present application is directed to a system of remotely monitoring the sound level at the location of a monitored person. The system includes a first device positioned with a monitored person, a monitoring server that is a hub for communication within the system, and a second device for a monitoring person that is remote from the first device and the monitored person. The first device is configured to detect the occurrence of sound exceeding a sound threshold. The first device then places a call to at least one of the monitoring server and the second device indicating that the sound threshold has been exceeded in the area of the monitored person.

The description of the system will be explained in the context of a wireless child monitoring system. The first device is a child device that is worn or otherwise carried by a child. The second device is used by a parent (or guardian) user when monitoring the child. The monitoring server acts as a hub of the system and communicates with both the child and parent devices. Although the system and methods will be explained in the context of this child monitoring system, the invention has broader applications and may be used in a variety of different contexts. Examples include but are not limited to monitoring an elderly person living alone, a hiker, a skier, and a camper.

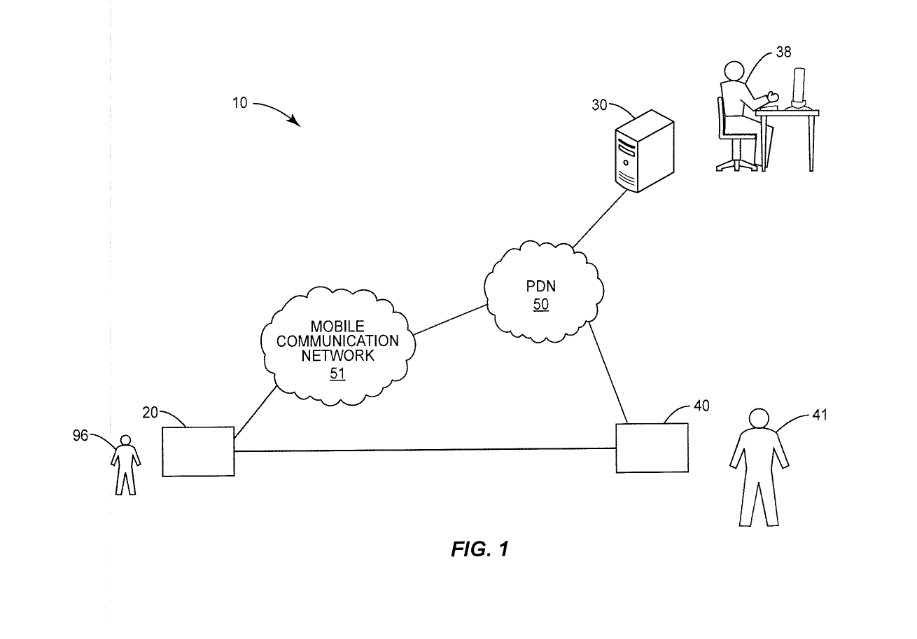

FIG. 1 schematically illustrates the child monitoring system 10 that includes the child device 20, parent device 40, and monitoring server 30. As illustrated, signaling from each of the child device 20 and parent device 40 flows through the monitoring server 30. In one embodiment, communication from the child device 20 to the parent device 40 occurs through the monitoring server 30. In another embodiment, the child device 20 can communicate directly with the parent device 40, such as through a direct cellular call.

In one embodiment, the system is configured for browser-based accessibility with communications through one or more networks. The entities may communicate through a Packet Data Network (PDN) 50 that comprises a packet-switched network that implements conventional protocols, such as the suite of Internet protocols. The PDN 50 may comprise a public or private network, and may include one or more wide area or local area networks. One example of a PDN 50 is the Internet. The browser-based interface may include well-known browsers such as Internet Explorer and Mozilla Firefox, or may also include specific applications to communicate with the monitoring server 30 over the PDN 50 (e.g., a smartphone application). The child device 20 may access the PDN 50 through a wireless communication network 51, such as Global System for Mobile Communications (GSM), Long Term Evolution (LTE), etc. Although not illustrated in FIG. 1, the parent device 40 may likewise access the PDN 50 through a wireless communication network according to a defined standard,

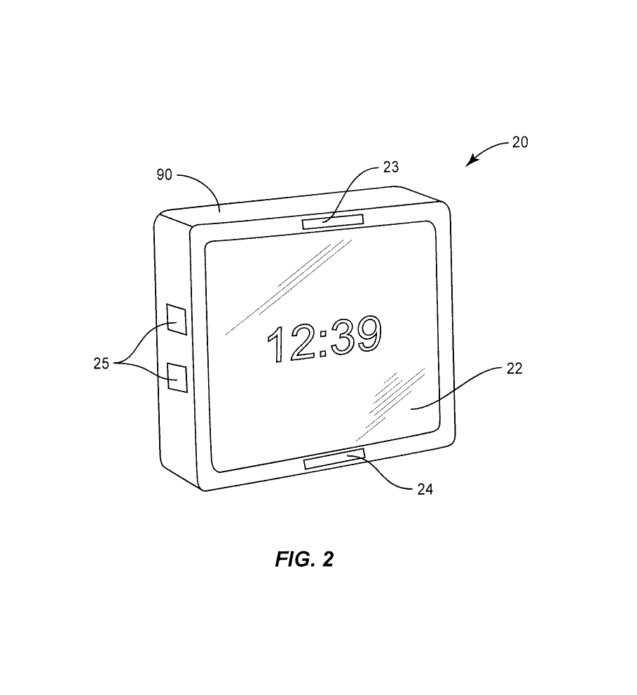

The child device 20 is sized and configured to be worn or carried by a child user 96. FIG. 2 illustrates one embodiment of the device 20 that includes a rigid housing 90 that protects the various internal components. The housing 90 may include one or more connectors (not illustrated) to receive a band for strapping to the child's wrist to be worn as a watch. The device 20 may also include an integral clip (not illustrated) that extends outward from the housing 90 to clip to the child's clothing, book bag, etc. The child device 20 further includes a display 22 for displaying various alpha-numeric information and various icons to the child. The device 20 further includes a speaker 23 and microphone 24 to enable communication with a remote party. One or more input buttons 25 may be positioned for controlling the functionality of the device 20.

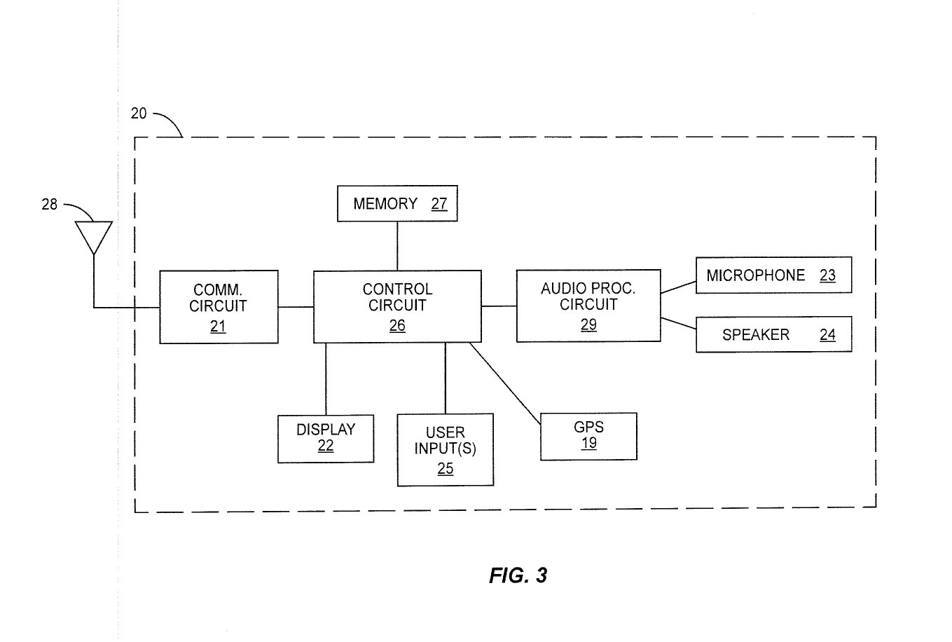

The child device 20 is configured to wirelessly communicate with the monitoring server 30. FIG. 3 illustrates a block diagram of a child device 20 that includes a control circuit 26 that controls the overall functioning of the device 20. The control circuit 26 may include one or more microprocessors, microcontrollers, Application Specific Integrated Circuits (ASICs), or other programmable devices. The control circuit 26 may be configured to execute program code stored within the device 20 or accessible by the device, to control the various components and their functions. For example, the program code may be stored in memory 27, or may be downloaded from the monitoring server 30.

Memory 27 may include one or several types of non-transitory memory, including, for example, read-only memory, flash memory, magnetic or optical storage devices, or the like. In some embodiments, one or more physical memory units may be shared by the various components. Other embodiments may have physically separate memories for one or more of the different components.

A communications circuit 21 provides wireless access to the PDN 50, to facilitate communication between the device 20 and the monitoring server 30. The circuit 21 may include a radio frequency transmitter and receiver for transmitting and receiving signals through an antenna 28. The communication circuit 21 is further configured for direct communication such as through a direct cellular call placed to a parent device 40. The communications circuit 21 may be further configured to send and receive information through various formats, such as but not limited to SMS text messages and files.

The display 22 provides viewable information for the child, such as the time, source of an incoming call, and the like. The display 22 may comprise any known electronic display, such as a liquid crystal display and a touch screen display. The user inputs 25 may include one or more control buttons that are exposed on the exterior of the housing 90, and inputs via a touch screen display. The inputs 25 provide for a user (e.g., the child user or another party) to enter various commands and make menu selections for menus presented on the display 22. The user inputs 25 may also include more intricate devices, such as a keypad, touchpad, touchscreen, and/or a joystick. A global positioning system (GPS) component 19 may be configured to receive coordinate information from various sources (e.g., satellites, base stations) to determine a geographic position of the child device 20.

The child device 20 further includes a microphone 23, speaker 24, and an audio processing circuit 29. The audio processing circuit 29 is configured to provide audio processing functionality for processing voice data for communications through the speaker 23 and microphone 24. The audio processing circuit 29 is further configured to detect, via the microphone 24, a sound level within the area of the device 20 and determine if the detected sound level exceeds a sound threshold. The audio processing circuit 29 is further configured to set the sound threshold level based on configuration data received from a remote input (e.g., the parent device 40) via the monitoring server 30.

FIG. 3 includes separate communication and audio processing circuits 21, 29. One or both of the functionality performed by these circuits 21, 29 may be included within the control circuit 26.

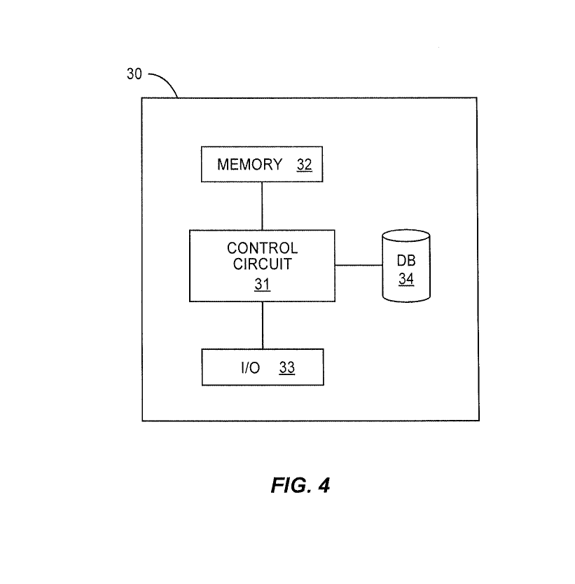

The monitoring server 30 provides for communications between the child device 20 and the parent device 40. FIG. 4 illustrates an example monitoring server 30 that includes a control circuit 31 that may include one or more microprocessors, microcontrollers, hardware circuits, and/or a combination thereof. Memory 32 stores program code used by the control circuit 31. Memory 32 may include various memory devices such as random access memory, read-only memory, and flash memory. A database 34 may be included in the memory 32, or in a separate memory unit (e.g., a magnetic or optical disk drive). The database 34 may be local or remote relative to the monitoring server 30. Thus, in one or more embodiments the database 34 is accessible to the monitoring server 30, but is stored externally on a separate server.

One or more input/output (I/O) interfaces 33 enable connectivity to the PDN 50. The interfaces 33 may also provide for a system administrator 38 (see FIG. 1) to control and configure the operation of the monitoring server 30.

The monitoring server 30 may be accessed by the parent device 40 using a browser-based interface. The browser-based interface may include a website through which the contents of the database 34 may be accessible. Although the website may be hosted by the monitoring server 30, it may also be hosted at another location accessible through the PDN 50.

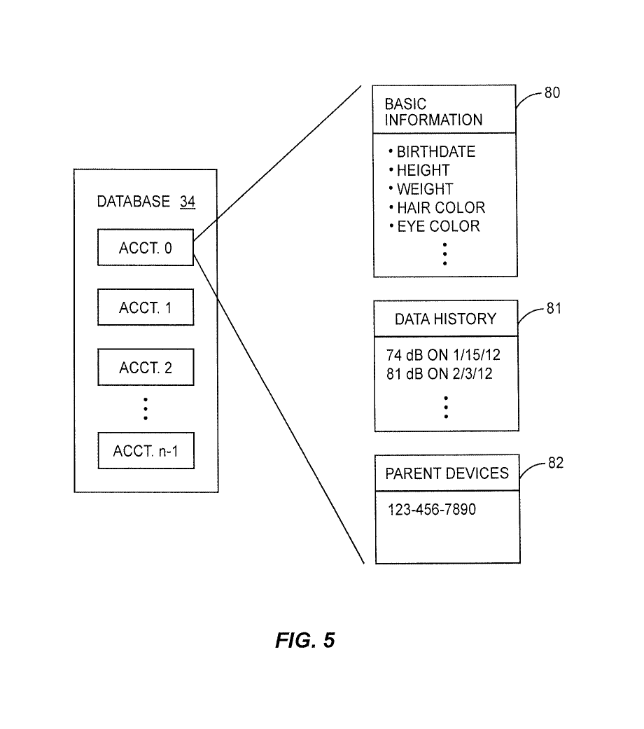

The monitoring server 30 maintains information about each child device 20 in the database 34. The information may include basic information 80 useful in the event of an emergency, such as a name, birthdate, height, weight, hair color, eye color, etc. of the child (see FIG. 5). The basic information may also include one or more photographs of the child. This information 80 may be entered at the time the child device 20 is initially configured within the system 10, and may be updated as necessary. The information may also include data experienced at the child device 20 (see “data history” 81 in FIG. 5). The data history 81 may include sound level information indicating the sound levels monitored at various times during the past. This may include raw data (e.g., periodically measured sound levels), aggregated data (e.g., average sound levels over larger periods of time), and/or excess sound occasions (e.g., sound levels when the sound threshold has been exceeded). The data history 81 may also include location information such as latitude and longitude at a specific time.

Each child account further includes an identifier 82 for the one or more authorized parent devices 40 that are permitted to access the child information in the account. Each of the authorized parent devices 40 are identified by one or more identifiers 82. The identifiers may include a telephone number, serial number, password, etc. that establishes the identity of the parent. One or more of these identifiers 82 is authenticated by the monitoring server 30 prior to providing access to this information. In the event that the one or more identifiers 82 are not authenticated, the device attempting to access the information will be denied access. Further, the monitoring server 30 may notify the one or more legitimate parent devices 40 regarding the attempted access to the child information.

The parent device 40 is configured to monitor the child device 20 through the monitoring server 30, and to receive a notification in the event that the child device 20 detects a sound level above the threshold. The parent device 40 may include a variety of different computing devices, including but not limited to a mobile cellular telephone, a smart phone, a tablet, a laptop computer, and a personal digital assistant (PDA).

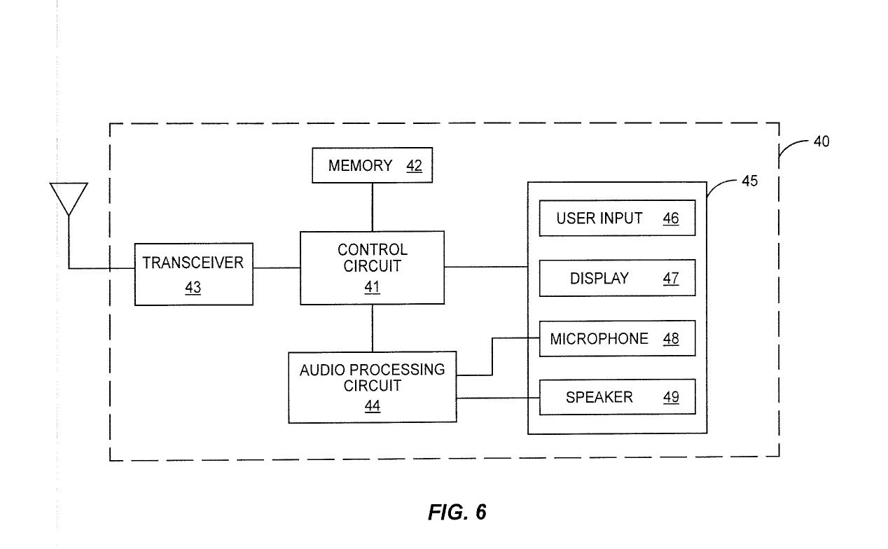

FIG. 6 illustrates a schematic block diagram of an exemplary parent device 40 according to one or more embodiments of the present invention. Parent device 40 includes a control circuit 41 that performs various processing tasks, including controlling the overall operation of the parent device 40 according to programs stored in memory 42. The control circuit 41 may include one or more microprocessors, microcontrollers, Application Specific Integrated Circuits (ASICs), or other programmable devices. The control circuit 41 may be configured to execute program code stored within the device 40 or accessible by the device 40, to control the various components and their functions. For example, the program code may be stored in memory 42, or may be downloaded from the monitoring server 30.

Memory 42 may include one or several types of non-transitory memory, including, for example, read-only memory, flash memory, magnetic or optical storage devices, or the like. In some embodiments, one or more physical memory units may be shared by the various components. Other embodiments may have physically separate memories for one or more of the different components.

To communicate with the monitoring server 30, parent device 40 includes at least one transceiver 43 coupled to an antenna. Transceiver 43 may operate according to any known standard, such as Global System for Mobile Communications (GSM), TIA/EIA-136, cdmaOne, cdma2000, UMTS, Wideband CDMA, and Long Term Evolution (LTE). In addition, transceiver 43 may include baseband processing circuits to process signals transmitted and received by the transceiver 43. Alternatively, baseband processing circuits may be incorporated with control circuit 41.

A user interface 45 includes one or more user input devices 46 and a display 47 that enables the parent user to interact with and control the device 40. The user input devices 46 may include a keypad, touchpad, joystick, control buttons, other input devices, or a combination thereof. User input devices 46 allow the operator to enter numbers, characters, or commands, and scroll through menus and select menu items presented to the parent user on an electronic display 47. The electronic display 47 allows the parent user to view information such as menus and menu items, dialed digits, images, call status information, and output from user applications (e.g., a web browser, or a dedicated application for accessing the monitoring server 30). User interface 45 may also include a microphone 48 and a speaker 49. An audio processing circuit 44 receives analog audio inputs from the microphone 48 and provides the basic analog output signals to speaker 49.

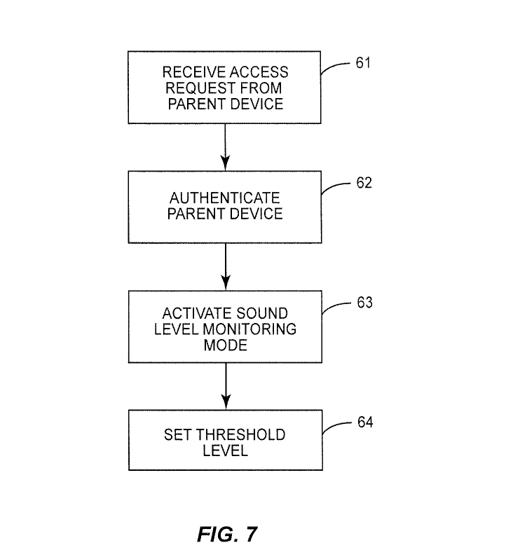

In use, the monitoring server 30 activates the sound level monitoring at the child device 20 based on input received from the parent device 40. FIG. 7 illustrates a method 60 performed by the monitoring server 30 to activate a “monitoring mode” in the child device 20. Initially, the monitoring server 30 receives an access request from the parent device 40 (step 61), with the access request including an identifier (ID) of both the parent device 40 and the child device 20. In one or more embodiments the IDs are stored in an application (e.g., browser or dedicated smartphone application) on the parent device 40. The monitoring server 30 then authenticates the parent device 40 to ensure that the parent device is authorized to activate and perform sound monitoring of the child device 20 (step 62). The parent device 40 may also be required to enter one or more passwords or other like information to establish authentication. In one or more embodiments the authentication includes a check that a subscription fee has been paid by the parent user. Once authenticated, the parent device 40 may activate the sound level monitoring mode on the child device 20, causing the child device 20 to enter the “monitoring mode” (step 63). The parent device 61 may also set the sound threshold level for the child device (step 64). This may be an initial setting of the level, or may be an adjustment of a previously set level.

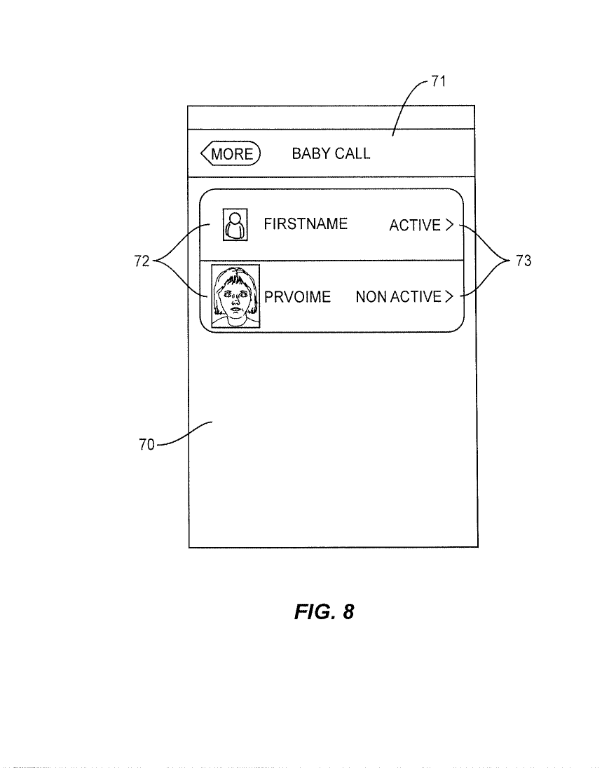

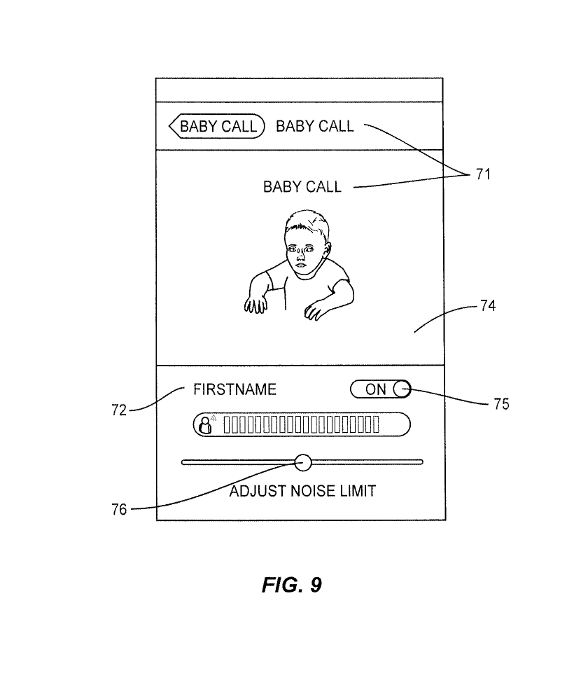

FIGS. 8 and 9 illustrate display screens 70, 74 that are viewed on the electronic display 47 of the parent device 40 to cause the child device 20 to enter the monitoring mode, and to perform adjustments in that mode. FIG. 8 illustrates a first display screen 70 through which the parent device 40 can select a child device 20 for which sound monitoring is desired. The display screen 70 includes a title (“Baby Call” in the example of FIG. 8) and also includes identifying information 72 about the various child devices 20 that are accessible to the parent device 40. In one embodiment, this may include each of the parent user's children. This may be useful if the parent has multiple children for which sound monitoring is desired. The identifying information 72 may include the name of the child and/or a photograph or icon. A status 73 for each child is also indicated on the display 70 indicating whether each child device 20 is in the monitoring mode (“Active”) or is not in the monitoring mode (“Non active”).

The parent user selects the appropriate child using the inputs 46 on the parent device 40. This input causes the second display screen 74 illustrated in FIG. 9 to be displayed on the parent device 40. Display screen 74 includes the title 71 and the identifying information 72 for the selected child device 20. An activation feature 75 is further displayed for the user to change the activation status. The activation feature 75 may include various formats, such as a switch as illustrated in FIG. 9 that can be toggled between on and off positions.

The display 74 further includes a sound threshold setting feature 76 that enables the user to set the sound level threshold at the child device 20 within a device range of sound scale. The feature 76 may include an adjustable slider that can be moved by the parent user as appropriate.

In one embodiment, the sound threshold feature 76 has a default setting. The default setting is established at the time of activation of the activation feature 75 (i.e., the time the child device 20 enters the monitoring mode). In one embodiment, the default setting is at a center position of the sound scale 77. The parent user than adjusts the sound threshold feature 76 away from the default setting as desired.

The inputs entered at the parent device 40 regarding the activation feature 75 and threshold setting feature 76 are sent to the monitoring server 30. The monitoring server 30 in turn signals the child device 20 to adjust its sound threshold accordingly based on the inputs.

Once activated, the child device 20 remains in the monitoring mode until the parent user returns to the display screen 74 and deactivates the feature 76. In another embodiment, the child device 20 remains in the monitoring mode for a predetermined period of time, and then deactivates into a “sleep mode” without any additional user input. The length of the period may be set at a default setting (e.g., 30 minutes), and may provide for the parent user to adjust the default setting as necessary. In one embodiment, display screen 74 includes an input that provides for the parent user to set the amount of time that the feature 76 remains active.

Activation of the monitoring mode may cause an indication to occur at the child device 20. This may include one or more of an icon or message appearing on the display 22 of the child device 20, or an audible indicator being sounded through the speaker 24 at the child device 20. The indication may occur once at the time of activation, or may occur periodically while the child device 20 remains in the monitoring mode. In one specific embodiment, a small icon is displayed on the display 22 of the child device 20 during the time that the child device 20 is in the monitoring mode.

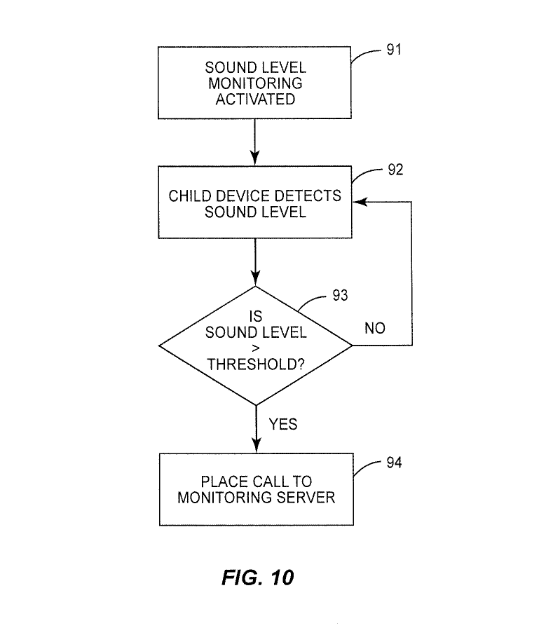

FIG. 10 illustrates a method 90 implemented by the child device 20 to perform sound level monitoring. The child device 20 is placed in the proximity of the child. This may include the device 20 being attached to the child, such as through a strap that connects the device to the child (e.g., a wrist strap or ankle strap) or a clip that attaches to the child's clothing or backpack. This may also include the device 20 being positioned in close proximity to the child, such as on a table adjacent to the child's crib or bed.

Initially, the sound level monitoring feature is activated (i.e., the monitoring mode is entered) and the sound level threshold is set based on input received from the monitoring server (step 91). Once activated, the child device 20 monitors the sound level in its surrounding environment (step 92). The sound level at the device 20 may be continuously sampled, or it may be sampled periodically at a desired time period. The child device 20 then determines whether the sound level exceeds the set threshold (step 93). This determination is performed by the audio processing circuit 29 within the child device 20. If the sound level remains below the threshold, the child device 20 continues the monitoring process.

If the sound level is determined to have exceeded the sound threshold, the child device 20 places a voice call to the monitoring server 30 (step 94). The call includes the sound captured by the microphone 23 that is currently occurring at the device 20. The monitoring server 30 may then route the call to the parent device 40. This provides for the parent to listen to what is occurring at the child device 20. The length of the call from the child device 20 may vary. In one embodiment, the call lasts for one minute at which time the call is terminated. In the event that the sound level at the child device 20 continues to exceed the sound threshold after call termination, a new call will be started by the child device 20. In addition to receiving the call from the monitoring server 30, the parent device 40 may also be configured to alert the parent user of the excessive sound level. This notification may include one or more of an icon or message that is displayed on the display 47, and a distinctive ring tone when the call is received from the monitoring server 30.

In one embodiment, the call placed to the parent device 40 merely provides for the parent to listen to the sound within the environment of the child (i.e., one-way communication). In other embodiments, the call provides for two-way communication for the parent to speak to the child.

The child device 20 may be configured to indicate that a call is being placed when the sound level is exceeded. This may include one or more of an icon or message on the display, an indicator light being activated, and an audible signal being transmitted from the speaker 24.

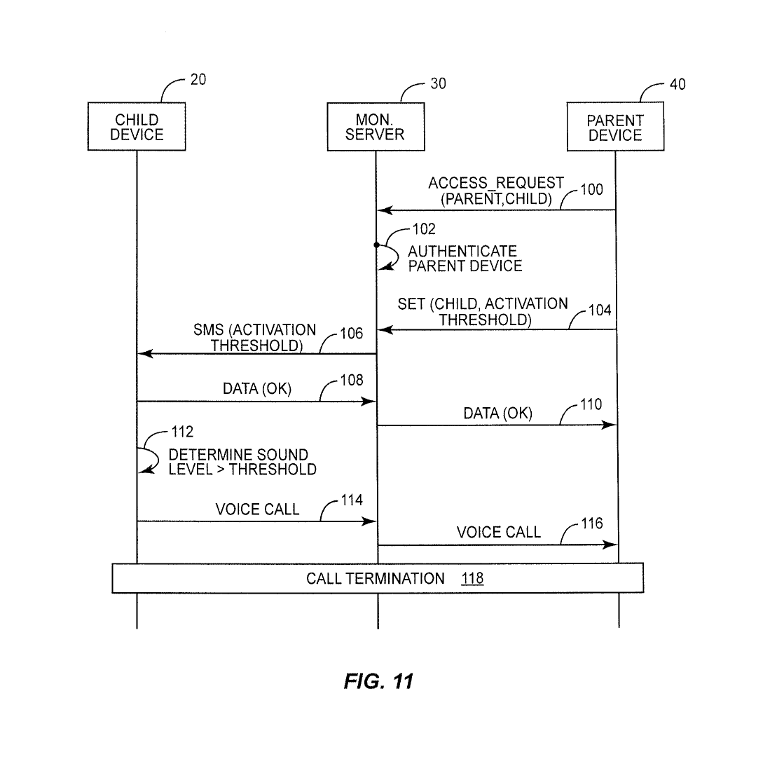

FIG. 11 illustrates a signaling diagram for a process of activating and using the sound level monitoring function. Initially, the parent device 40 transmits an access request message including an identifier for both the parent device 40 and the child device 20 for which monitoring is desired (step 100). The monitoring server 30 authenticates the parent device 40 to ensure that sound monitoring of the identified child device is authorized by the parent device and then establishes a session with the monitoring server 30 (step 102). The parent device 40 also sends a message (step 104) to the monitoring server 30 that includes the child device ID, an activation of the sound level monitoring (causing the child device 20 to enter the monitoring mode) and a sound level threshold. The monitoring server 30 then sends a message to the child device 20 that includes the activation request and the threshold (step 106). Responsive to receiving the message of step 106, the child device 20 enters the monitoring mode and adjusts its audio processing circuit 29 accordingly to implement the desired threshold. The child device 20 may send an acknowledgement receipt to the monitoring server 30 (step 108). The monitoring server 30 may further send an acknowledgement to the parent device 40 (step 110) to indicate that the child device 20 has entered the monitoring mode, and that the desired threshold has been implemented.

Once the sound level monitoring is activated and the threshold level is set, the child device 20 samples the sound level within its environment, and compares that measured sound level with the sound threshold. At some point thereafter, the child device 20 detects that the sound level exceeds the sound threshold (step 112). Based on the sound threshold being exceeded, the child device 20 sends a voice call to the monitoring server 30 (step 114) that includes the sound that is currently being obtained through the microphone 23 of the child device 20. The monitoring server 30 correspondingly places a call to the parent device 40 with this information (step 116). Thus, the monitoring 30 server acts as a conduit for transmissions between the child device 20 and the parent device 40. This call may last for a predetermined period of time. In one specific embodiment, the call last for one minute. After the time period has expired (or responsive to termination of the call by the parent user), the child device 20 terminates the call (step 118).

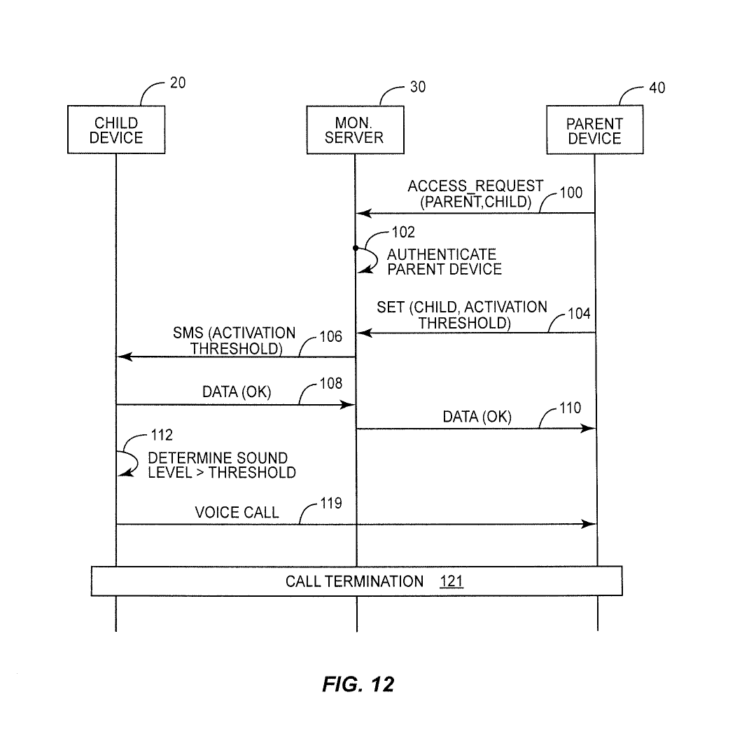

FIG. 12 illustrates another embodiment of the sound monitoring process. Steps 100-112 are the same as described above for FIG. 11. After the child device 20 determines that the sound level is greater than the threshold (step 112), the child device 20 places a voice call directly to the parent device 40 (step 119). The call is not routed through the monitoring server 30 as in the previous method. In one embodiment, the call may be a one-way call in which the parent device 40 is able to listen to the sound that is occurring at the child device 20 that are detected through the microphone 23 of the child device 20. This may include any sounds made by the child. In another embodiment, the call is a two-way communication with the parent device 40 being able to also communicate with the child device 20.

In one embodiment, the child device 20 places the call to the parent device 40 that activated the sound level monitoring. The child device 20 may also place a call to other devices that are stored in its memory 27. In one embodiment, the child device 20 initially attempts to contact the parent device 40 that established the sound level monitoring. If this attempt is unsuccessful (e.g., the parent does not answer the call), the child device 20 may then attempt to call the next device on their list. This process may continue until the occurrence of a successful connection. In another embodiment, the child device 20 simultaneously calls two or more different devices 40.

The various calls to the parent device(s) 40 may last for a predetermined period of time. In one specific embodiment, the call lasts for one minute. After the time period has expired (or responsive to termination of the call by the parent user), the child device 20 terminates the call (step 121).

In the embodiment of FIG. 12, the child device 20 may also notify the monitoring server 30 that the sound threshold has been exceeded. This may occur through a variety of different communication formats. The monitoring server 30 may store this information for future reference by a parent device 40.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A sound level monitoring system comprising:
a first device configured to be positioned at the monitored location, the first device comprising:
a microphone configured to detect sound at the first device;
a first communication circuit configured to communicate through a wireless communication network;
a control circuit configured to:
set a sound level threshold based on an input received through the wireless communication network;
determine a sound level at the device;
determine that the sound level at the device exceeds the sound level threshold; and
place a voice call through the wireless communication network that includes the sound occurring at the child device;
a second device configured to be remotely positioned away from the first device and comprising a second communication circuit configured to communicate through the wireless communication network;
a control server configured to communicate with both the first and second devices through the wireless communication network, the control server being remotely positioned away from both of the first and second devices;
the control server maintaining information about the first device including sound levels monitored during past events at the first device.

2. The system of claim 1, wherein the information maintained by the control server further includes user information including a name, birthdate, height, and a physical description of a user of the first device.

3. The system of claim 1, wherein the information maintained by the control server further includes a photograph of a user of the first device.

4. The system of claim 1, wherein the information maintained by the control server further includes periodically measured sound levels at the first device.

5. The system of claim 1, wherein the information maintained by the control server further includes excessive sound levels previously measured at the first device that exceed a threshold.

6. The system of claim 1, wherein the control circuit is configured to display an indicator on a display screen when a sound level monitoring mode is active within the first device and the sound level is being detected.

7. The system of claim 1, wherein the first device further includes a global positioning system component operatively connected to the control circuit and configured to determine a geographic position of the first device.

8. A method implemented by a monitoring server of remotely monitoring a sound level at a monitored wireless communication device, the method comprising:
receiving an access request at a monitoring server from a monitoring device that includes a first identifier of the monitoring device and a second identifier of the monitored device, the monitoring device being remotely located from the monitored device and the monitoring server;
authenticating the monitoring device at the monitoring server based on the first identifier of the monitoring device;
after authenticating the monitoring device, sending an activation request to the monitored device to activate a sound level monitoring mode at the monitored device, and
sending a sound level threshold to the monitored device based on input received from the monitoring device.

9. The method of claim 8, further comprising maintaining the monitored device in the sound level monitoring mode until sending a deactivation requested to the monitored device.

10. The method of claim 8, further comprising maintaining the monitored device in the sound level monitoring mode for a predetermined time period from sending the activation request.

11. The method of claim 8, further comprising receiving at the monitoring server an indication from the monitored device that the sound level threshold has been exceeded at the monitored device.

12. The method of claim 11, further comprising notifying the monitoring party that the sound level threshold has been exceeded by sending the sound occurring at the monitored device at the time.
